(19) United States
(12) Patent Application Publication
(10) Pub. No.: US 2004/0141173 A1
(43) Pub. Date: Jul. 22, 2004

(54) Information processing device

(76) Inventor: Junichi Rekimoto, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/466,254

(22) PCT Filed: Jan. 9, 2002
(86) PCT No.: PCT/JP02/00037

(30) Foreign Application Priority Data
Jan. 11, 2001 (JP) 2001-3894

(51) Int. Cl. G01C 1/00; G01B 11/26

(52) U.S. Cl. 356/141.5

(57) ABSTRACT

The present invention relates to an information processing apparatus in which providing various information is made possible with a simple configuration. Light beacons 2-1 to 2-5 are arranged at predetermined positions in an area 1 and generate their respective identification numbers as optical signals. In a detection section 5, a video camera 4 within the area 1 receives an optical signal from each of the light beacons and detects the position of each light beacon and its own position based on the principle of triangulation. In an image captured by the video camera 4, information corresponding to the detected identification number is displayed. The present invention is applicable to the light beacons, and the detection section for detecting the positions of the light beacons and which is included in the video camera.

### TECHNICAL FIELD

The present invention relates to an information processing apparatus and method, and a program, and particularly to an information processing apparatus and method, and a program that make it possible, with a simple configuration, to provide various information.

### BACKGROUND ART

The present applicant previously proposed, as, for example, Published Application JP2000-194726, providing a more effective user interface by making augmented reality a bi-directional system.

In this previous proposal, in which room a user is located is made to be recognized with an infrared beacon, and also, by attaching a two-dimensional bar code to a video cassette recorder in that room and reading the two-dimensional bar code, which apparatus in which room it is is recognized, and information regarding that video cassette is provided to the user.

However, in the previous proposal, because there is a need to attach the two-dimensional bar code to the video cassette recorder in addition to providing the infrared beacon, there was a problem in that not only does the configuration of the system become complicated, but also in that it is difficult to develop the system into one that is more desirable for the user.

### DISCLOSURE OF THE INVENTION

The present invention has been made in view of such circumstances, and is one that makes it possible to realize more easily various systems for providing a user with various information without complicating the configuration.

An information processing apparatus of the present invention is characterized in that it has receiving means for receiving optical signals generated by a plurality of generating apparatuses arranged at predetermined positions; and detection means for detecting identification information of the generating apparatuses and the directions of the generating apparatuses based on the signals received by the receiving means.

The detection means mentioned above may be made to include photo-electric conversion means for generating a voltage corresponding to the direction from which the optical signal is received.

The detection means mentioned above may be made to further detect the position of the information processing apparatus.

It can be made to further have display means for displaying the position of the information processing apparatus detected by the detection means mentioned above.

It can be made to further have display means for displaying, based on the identification information detected by the detection means mentioned above, a GUI corresponding thereto.

A first information processing method of the present invention is characterized in that it includes a receiving step of receiving optical signals generated by a plurality of generating apparatuses arranged at predetermined positions; and a detection step of detecting identification information of the generating apparatus and the direction of the generating apparatus based on the signal received in the process of the receiving step.

A first program of the present invention causes a computer to perform: a receiving step of receiving optical signals generated by a plurality of generating apparatuses arranged at predetermined positions; and a detection step of detecting identification information of the generating apparatus and the direction of the generating apparatus based on the signal received in the process of the receiving step.

In the information processing apparatus and method, and the program of the present invention, the optical signals generated by the plurality of generating apparatuses are received, and the identification information of the generating apparatus and the direction of the generating apparatus are detected based on the received signal.

An information processing system of the present invention is characterized in that a generating apparatus has generation means for generating an optical signal including identification information for identifying itself such that it does not coincide with the timing in which another generating apparatus generates an optical signal, and an information processing apparatus has receiving means for receiving the optical signal generated by the generation means and detection means for detecting the identification information of the generating apparatus and the direction of the generating apparatus based on the signal received by the receiving means.

A second information processing method of the present invention is characterized in that an information processing method of a generating apparatus includes a generation step of generating an optical signal including identification information for identifying the generating apparatus such that it does not coincide with the timing in which another generating apparatus generates an optical signal, and in that an information processing method of an information processing apparatus includes a receiving step of receiving the optical signal generated in the process of the generation step, and a detection step of detecting the identification information of the generating apparatus and the direction of the generating apparatus based on the signal received in the process of the receiving step.

In a second program of the present invention, a program of a generating apparatus includes a generation step of generating an optical signal including identification information for identifying the generating apparatus such that it does not coincide with the timing in which another generating apparatus generates an optical signal, and a program of an information processing apparatus includes a receiving step of receiving the optical signal generated in the process of the generation step, and a detection step of detecting the identification information of the generating apparatus and the direction of the generating apparatus based on the signal received in the process of the receiving step.

In the information processing system and method, as well as the program of the present invention, a plurality of generating apparatuses generate optical signals, and an information processing apparatus detects identification information of the generating apparatuses and the directions of the generating apparatuses based on the received signal.

### BRIEF DESCRIPTION OF THE DRAWINGS

FIG. 1 is a diagram showing a configuration example of an information processing system to which the present invention is applied.

FIG. 2 is a block diagram showing a configuration example of a light beacon of FIG. 1.

FIG. 3 is a block diagram showing a configuration example of a control apparatus of FIG. 1.

FIG. 4 is a block diagram showing a configuration example of a video camera of FIG. 1.

FIG. 5 is a block diagram showing a configuration example of a detection section of FIG. 1.

FIG. 6 is a diagram showing a configuration example of a PSD of FIG. 5.

FIG. 7 is a diagram illustrating an ID decoding process by the detection section of FIG. 5.

FIG. 8 is a diagram illustrating a position detecting operation by the detection section of FIG. 5.

FIG. 9 is a diagram showing a waveform the PSD of FIG. 8 outputs.

FIG. 10A is a diagram illustrating the controlling of the timing for optical signal transmission of each light beacon by the control apparatus of FIG. 1.

FIG. 10B is a diagram illustrating the controlling of the timing for optical signal transmission of each light beacon by the control apparatus of FIG. 1.

FIG. 10C is a diagram illustrating the controlling of the timing for optical signal transmission of each light beacon by the control apparatus of FIG. 1.

FIG. 10D is a diagram illustrating the controlling of the timing for optical signal transmission of each light beacon by the control apparatus of FIG. 1.

FIG. 10E is a diagram illustrating the controlling of the timing for optical signal transmission of each light beacon by the control apparatus of FIG. 1.

FIG. 11 is a flowchart illustrating a process by the detection section of FIG. 1.

FIG. 12 is a flowchart illustrating a process by the video camera of FIG. 1.

FIG. 13 is a flowchart illustrating a process by the control apparatus of FIG. 1.

FIG. 14 is a diagram showing examples of information corresponding to identification numbers.

FIG. 15 is a diagram showing a display example in step S15 of FIG. 12.

FIG. 16 is a block diagram showing a configuration example of a portable terminal.

FIG. 17 is a flowchart illustrating an operation of the portable terminal of FIG. 16.

FIG. 18 is a diagram showing a display example in step S36 of FIG. 17.

FIG. 19 is a diagram showing a configuration example of another information processing system of the present invention.

FIG. 20 is a diagram showing the configuration of a VCR of FIG. 19.

FIG. 21 is a block diagram showing an internal configuration example of the VCR of FIG. 19.

FIG. 22 is a block diagram showing a configuration example of a remote commander of FIG. 19.

FIG. 23 is a flowchart illustrating a GUI display process by the remote commander of FIG. 19.

FIG. 24 is a diagram showing a display example in step S53 of FIG. 23.

FIG. 25 is a flowchart illustrating an apparatus control process by the remote commander of FIG. 19.

### BEST MODES FOR CARRYING OUT THE INVENTION

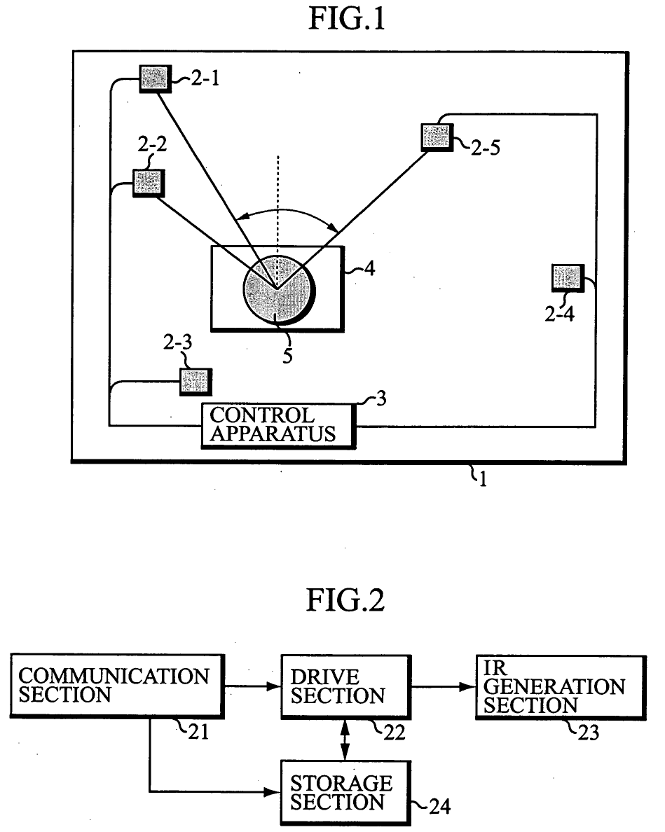

FIG. 1 represents a configuration example of an information processing system to which the present invention is applied. In this configuration example, light beacons 2-1 to 2-5 (hereinafter referred to simply as light beacons 2 when these light beacons do not need to be differentiated individually) are arranged at predetermined positions in an area 1. The light beacons 2-1 to 2-5 are connected through a wire or wirelessly to a control apparatus 3, and generate infrared signals in a predetermined timing.

Infrared signals emitted from each of the light beacons 2-1 to 2-5 are received by a detection section 5 attached to a video camera 4 carried by a user.

The light beacons 2 are configured as shown in FIG. 2, for example. A communication section 21 communicates with the control apparatus 3, controls a drive section 22 in a predetermined timing, and generates an infrared signal from an IR (infrared) generation section 23. A storage section 24 stores an identification number of that light beacon 2. This identification number may be stored in the storage section 24 after being supplied from the control apparatus 3 via the communication section 21. Or alternatively, it can be stored in the storage section 24 in advance. The drive section 22 controls the IR generation section 23 based on the identification number stored in the storage section 24, and generates an infrared signal in which a carrier of a predetermined frequency is pulse-modulated.

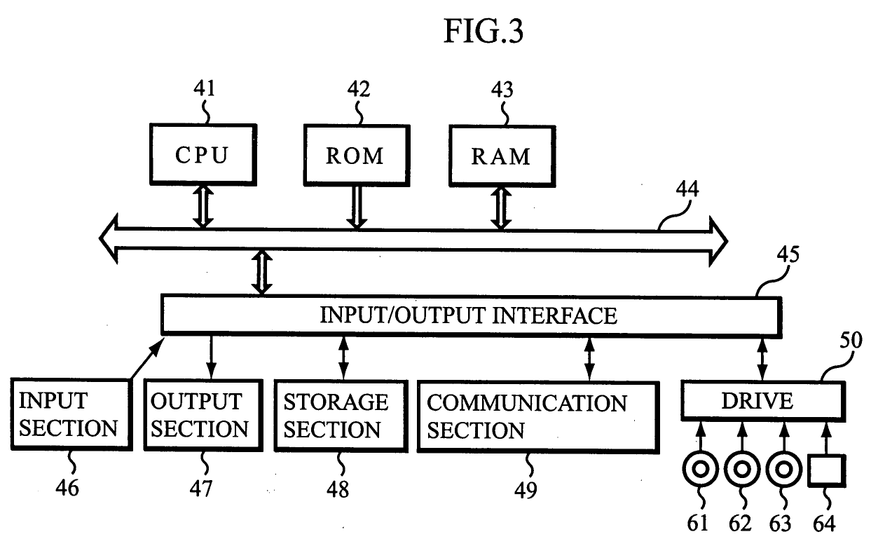

The control apparatus 3 is configured as shown in FIG. 3, for example. A CPU (Central Processing Unit) 41 executes various processes according to programs stored in a ROM (Read Only Memory) 42 or programs loaded into a RAM (Random Access Memory) 43 from a storage section 48. Data that is necessary for the CPU 41 to execute various processes and the like are also stored in the RAM 43 as appropriate.

The CPU 41, the ROM 42, and the RAM 43 are interconnected via a bus 44. An input/output interface 45 is also connected to this bus 44.

Connected to the input/output interface 45 are an input section 46 including a keyboard, a mouse and the like, an output section 47 configured with a display, such as a CRT or an LCD, speakers and the like, a storage section 48 configured with a hard disk and the like, and a communication section 49 configured with a modem, a terminal adapter, a network interface and the like. The communication section 49 performs a communication process with the light beacons 2 and the video camera 4.

To the input/output interface 45 is also connected a drive 50 as required, and a magnetic disk 61, an optical disc 62, a magneto-optic disc 63, a semiconductor memory 64 or the like is loaded as appropriate, and computer programs read therefrom are installed to the storage section 48 as required.

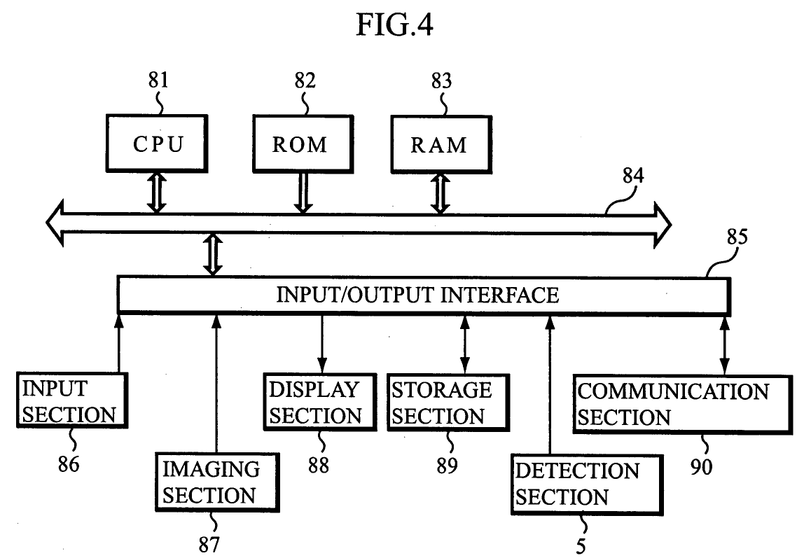

The video camera 4 is configured as shown in FIG. 4, for example. A CPU 81, a ROM 82, a RAM 83, a bus 84, and an input/output interface 85 basically have functions similar to the CPU 41, the ROM 42, the RAM 43, the bus 44, and the input/output interface 45 in the control apparatus 3 of FIG. 3, respectively, and thus, descriptions thereof will herein be omitted.

An input section 86 connected to the input/output interface 85 is configured with buttons, switches and the like, and is operated by the user as required. An imaging section 87 captures a subject. A display section 88 displays images captured by the imaging section 87, images recorded by a recording section 89, and the like. A communication section 90 communicates with the communication section 49 of the control apparatus 3 wirelessly.

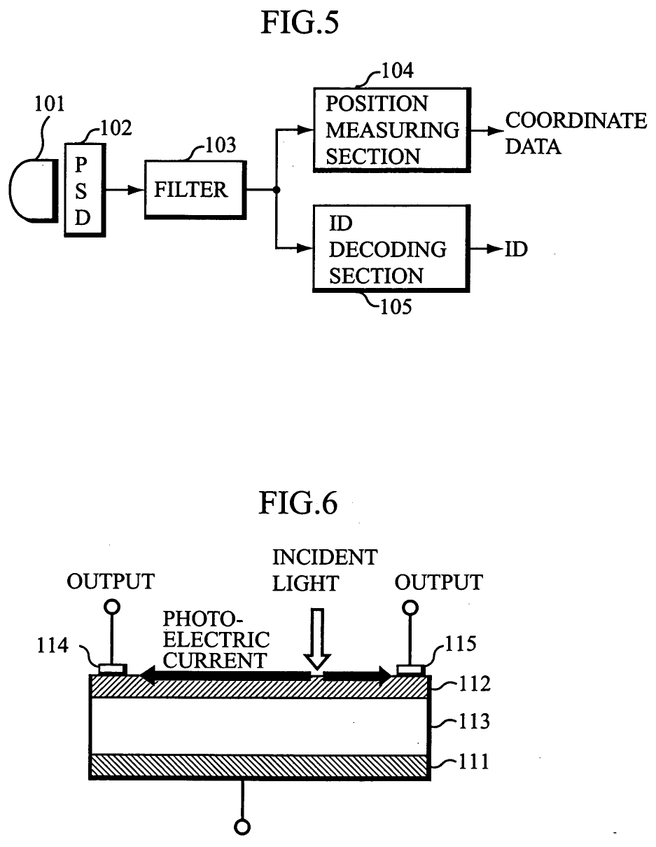

The detection section 5 is configured as shown in FIG. 5, for example. An optical system 101 includes lenses, and causes infrared signals emitted from the light beacons 2 to enter a PSD (Position Sensitive Detector) 102. The PSD 102 is configured as shown in FIG. 6, for example.

In other words, the PSD 102 has an I layer 113 between a P layer 112 and an N layer 111, and an electrode 114 and an electrode 115 are provided at one end and the other end of the P layer 112, respectively. When light (an infrared signal in the present case) hits a predetermined position of the electrodes 114 and 115, a charge corresponding to the incident light is generated, and is outputted from the electrode 113 and the electrode 115 as a photo-electric current. Since the resistance layer through which the photo-electric current passes is so configured as to have a uniform resistance value, the value of the photo-electric current outputted from the electrode 114 and the electrode 115 is divided in reverse proportion to the distance between the incident position of the light and the electrode 114 or the electrode 115 (resistance value). Therefore, it is possible to find the incident position of the optical signal between the electrode 114 and the electrode 115 based on the output voltage of the electrode 114 and the electrode 115.

By arranging the configuration shown in FIG. 6 two-dimensionally, it is possible to measure the two-dimensional incident position of the light.

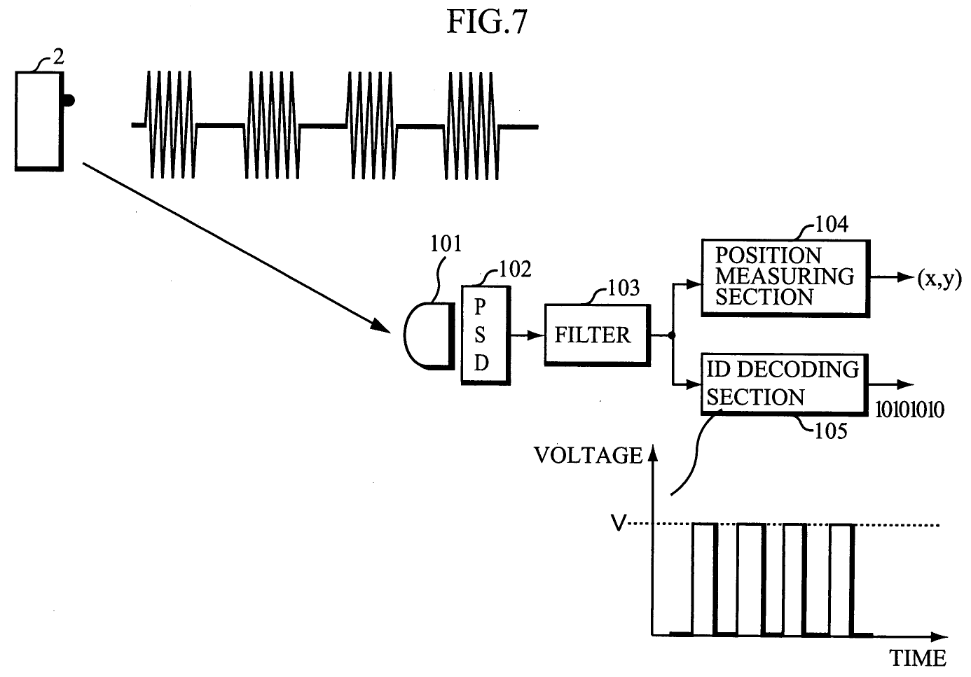

The signal outputted from the PSD 102 enters a filter 103, only a component of a predetermined frequency band (the frequency band of the carrier) is extracted, and is supplied to a position measuring section 104 and an ID decoding section 105. Based on the inputted signal, the position measuring section 104 measures the position of the light beacon 2 that generated that optical signal (that is, the position of the detection section 5 (the video camera 4)) (the principle thereof will be described later with reference to FIG. 7).

The ID decoding section 105 decodes an identification number (ID) from the inputted signal.

FIG. 7 represents the principles for detecting the position of the light beacon 2 based on an infrared signal the light beacon 2 outputs. As described above, the light beacon 2 pulse-modulates a carrier of a predetermined frequency based on its own identification number, and outputs it as an infrared signal.

This infrared signal enters a predetermined position of the PSD 102 via the optical system 101 in the detection section 5. The PSD 102 outputs a signal of a voltage corresponding to the incident light. The filter 103 extracts a frequency component of the carrier the light beacon 2 outputs, and outputs it to the position measuring section 104 and the ID decoding section 105. Therefore, a pulse signal that changes according to the identification number of the light beacon 2 is inputted to the position measuring section 104 and the ID decoding section 105.

The ID decoding section 105 decodes the identification number (ID) by decoding this pulse signal.

The incident position of an optical signal to the PSD 102 differs, as shown in FIG. 1, depending on which position the light beacon 2 is placed at. In the example of FIG. 1, the infrared signal from the light beacon 2-2 enters a position on the leftmost side of the PSD 102, the infrared signal from the light beacon 2-1 enters a position slightly to the right side thereof, and the infrared signal from the light beacon 2-5 enters a position on the rightmost side.

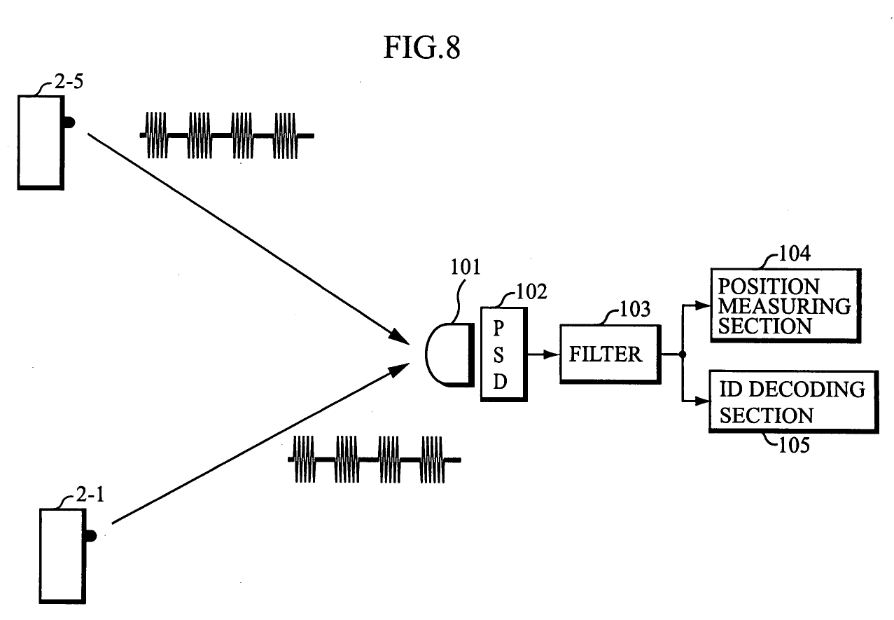

FIG. 8 shows, enlarged, how the infrared signal emitted from the light beacon 2-1 and the infrared signal emitted from the light beacon 2-5 each enter different positions of the PSD 102. As described above, the voltage of a pulse signal the PSD 102 outputs changes according to the incident position of that optical signal.

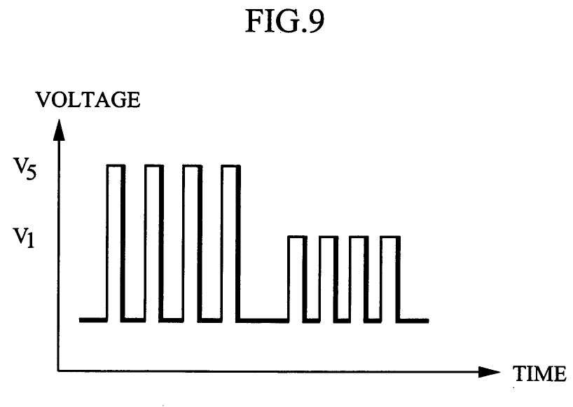

For example, if it is assumed that the PSD 102, when the incident position of an optical signal is towards the left side in FIG. 8, outputs a low voltage, and when the incident position of an optical signal is towards the right side, outputs a high voltage, then as shown in FIG. 9, the peak value of the voltage the PSD 102 outputs is V₁ when the infrared signal from the light beacon 2-1 is received, and is V₅ when the infrared signal the light beacon 2-5, which is positioned more towards the right side, outputs is received. The voltage V₅ is greater than the voltage V₁.

The position measuring section 104 detects the direction of an infrared signal incident to the PSD 102 (the direction of the light beacon 2) based on this voltage (the peak voltage). Further, since the light beacon 2 that generated that infrared signal can be identified based on the identification number decoded by the ID decoding section 105, as a result, it is possible to find which light beacon 2 is positioned in which direction by the position measuring section 103 and the ID decoding section 105.

And, if, for example, infrared signals from at least two directions within a horizontal plane can be received, the relative position of the detection section 5 to these two light beacons 2 within the horizontal plane can be found based on the so-called principle of triangulation. Similarly, by receiving infrared signals from at least two directions within a vertical plane, the position within the vertical plane can also be found. Therefore, if infrared signals from three light beacons 2 can be received from different directions, the three-dimensional position of the detection section 5 relative thereto can be found.

Furthermore, if the absolute positions of the light beacons 2 are known, it is also possible to detect the absolute position of the detection section 5 (the video camera 4). This positional information may be recorded in the recording section 89 of the video camera 4 in advance, or may be obtained by communicating with the control apparatus 3 as required.

However, when a plurality of light beacons 2 output optical signals simultaneously, because these optical signals enter the PSD 102 simultaneously, they both interfere, and it becomes difficult to identify which optical signal has been received.

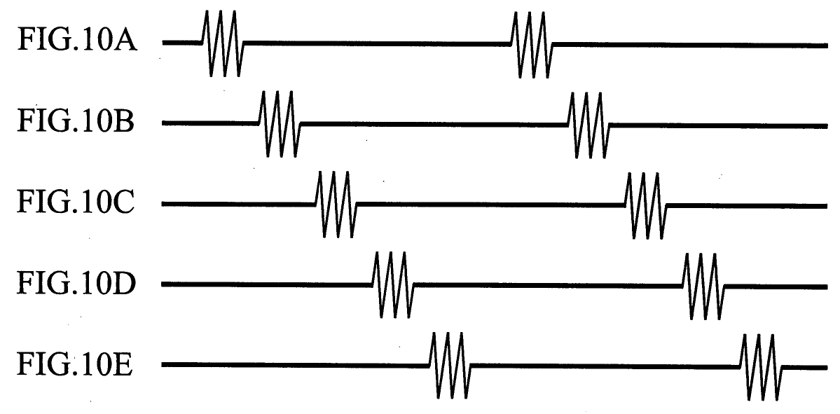

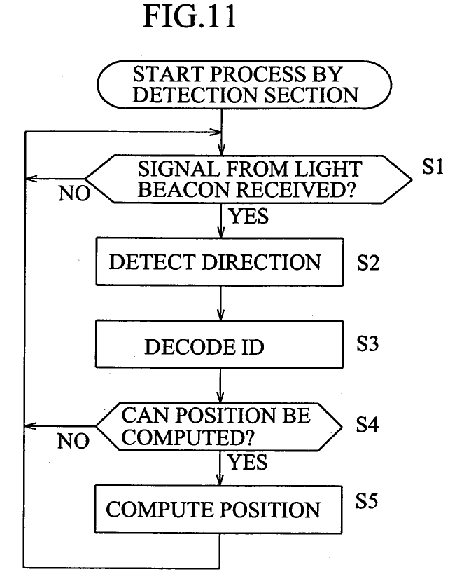

As such, the CPU 41 of the control apparatus 3 communicates with the communication sections 21 of the light beacons 2 via the communication section 49, and as shown in FIG. 10, controls the respective light beacons 2 such that their timings for outputting infrared signals will not coincide. In other words, in the example of FIG. 10, the light beacons 2-1 to 2-5 are controlled so as to generate their optical signals sequentially in different timings as shown in FIG. 10A through FIG. 10E.

Next, a process by the detection section 5 will be described with reference to the flowchart of FIG. 11. The PSD 102 waits until it receives an optical signal from the light beacon 2, and when an optical signal is received, it photo-electrically converts the received optical signal. The photo-electrically converted signal is inputted to the filter 103, and only a predetermined carrier component is extracted. The signal outputted from the filter 103 is inputted to the position measuring section 104 and the ID decoding section 105.

As described above, the voltage of the signal inputted to the position measuring section 104 changes depending on the position at which the infrared signal enters the PSD 102. Thus, the position measuring section 104 detects, in step S2, the direction of the light beacon 2 from the PSD 102 based on this voltage.

In step S3, the ID decoding section 105 detects the identification number (ID) by decoding the inputted pulse signal.

Thus, for example, when an infrared signal from the light beacon 2-1 is received, its direction and identification number are detected.

Next, in step S4, the position measuring section 104 determines in step S4 whether or not the position of the detection section 5 can be computed from the direction and identification number obtained through the processes of steps S2 and S3, and if it is determined that it cannot be computed, the process returns to step S1, and processes of steps S2 and S3 are executed again. Thus, for example, when an infrared signal from the light beacon 2-5 is received, its direction is detected by the position measuring section 104 and its identification number is detected by the ID decoding section 105.

Thus, when the directions of at least two light beacons 2 are detected in this way, the position measuring section 104 is able to compute the position of the detection section 5 relative to the light beacons 2-1 and 2-5 based on the principle of triangulation. So, the process proceeds from step S4 to step S5, and the position measuring section 104 computes the relative position of the detection section 5 within a horizontal plane or a vertical plane based on the principle of triangulation.

Thereafter, the process returns to step S1, the processes subsequent thereto are repeated, and the three-dimensional position of the detected object 5 with respect to the light beacons 2 (the three-dimensional position of each light beacon 2 with respect to the detection section 5) is detected.

Thus, the detection section 5 repeatedly performs the process of constantly detecting the position of itself (the video camera 4) (the position of the light beacon 2).

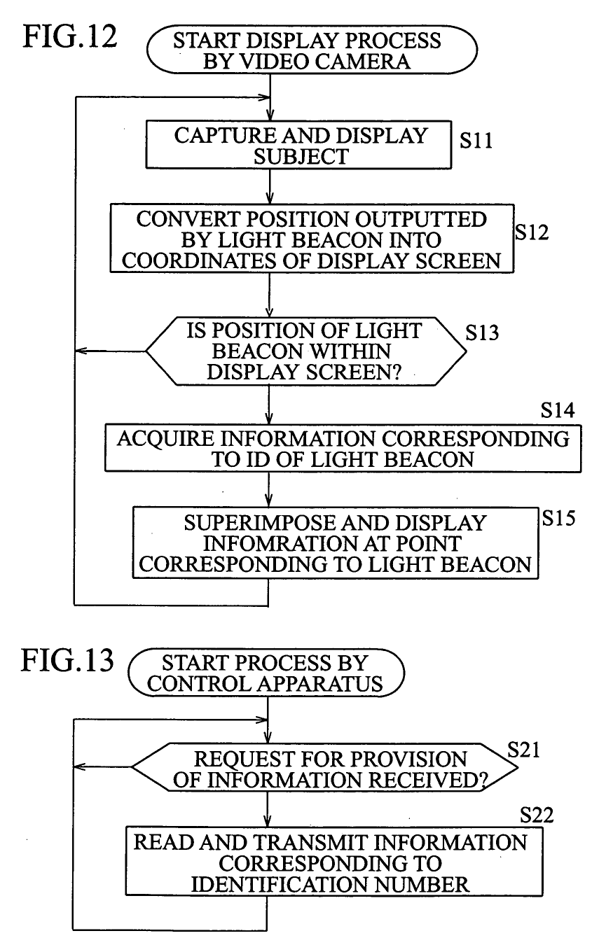

Next, a display process by the video camera 4 will be described with reference to the flowchart of FIG. 12.

In step S11, the CPU 81 controls the imaging section 87 to capture a subject. Image data obtained as the result of the capturing is supplied to and stored in the RAM 83, while at the same time it is read therefrom, outputted to the display section 88, and displayed.

Next, in step S12, the CPU 81 converts the position of the light beacon 2 outputted from the detection section 5 into coordinates on a display screen that was captured and displayed in step S11. And in step S13, the CPU 81 determines whether or not the position of the light beacon is within the display screen. If the position of the light beacon 2 is not within the display screen, the process returns to step S11, and the processes subsequent thereto are repeatedly executed.

If it is determined in step S13 that the position of the light beacon 2 is located within the display screen, the process proceeds to step S14, and the CPU 81 performs a process of acquiring information corresponding to the identification number of that light beacon. In other words, at this point, the CPU 81 controls the communication section 90, transmits the identification number of the light beacon detected by the detection section 5 to the control apparatus 3, and requests the transmission of information corresponding thereto.

Upon receipt of this request via the communication section 49, the CPU 41 of the control apparatus 3 determines in step S21 of FIG. 13 that a request for the provision of information has been received, and in step S22, reads information corresponding to the identification number stored in the storage section 48, and executes a transmission process from the communication section 49 to the video camera 4.

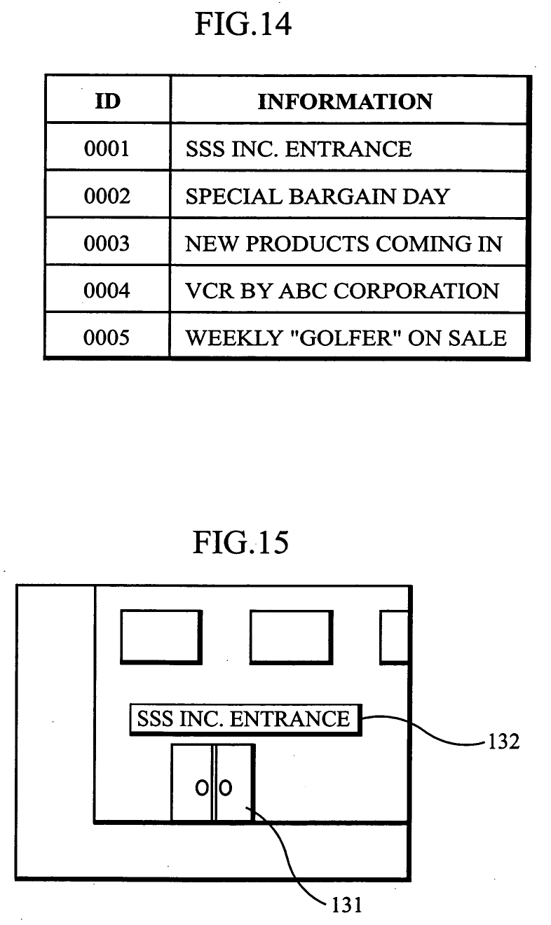

In other words, in the storage section 48 of the control apparatus 3, as shown in, for example, FIG. 14, information is registered so as to correspond to the identification number (ID) of each light beacon 2-1 to 2-5. The CPU 41 reads this information, controls the communication section 49 to transmit it to the video camera 4.

Upon receipt of this information via the communication section 90, the CPU 81 of the video camera 4, in step S15, writes that information to the RAM 83 based on the coordinates of a point corresponding to that position of the light beacon 2, and reads and displays it on the display section 88.

Thus, information corresponding to the identification number of the light beacon 2 as shown in FIG. 15, for example, is superimposed and displayed on the captured image displayed on the display section 88. In the example of FIG. 15, the provided information (a message in the case of this example) is displayed as an image 132 above an entrance 131 to a building captured by the imaging section 87. In this display example, displayed is a message “SSS INC. ENTRANCE” which is provided as information corresponding to the identification number “0001” of the light beacon 2-1.

Thereafter, the process returns to step S11, and processes subsequent thereto are repeatedly executed.

Note that the information to be superimposed and displayed may also be stored in the recording section 89 of the video camera 4 in advance.

In the above, various information was provided to a user according to the identification number of the light beacon 2 (the position of the light beacon 2). It may also be arranged, however, such that a user positioned in the area 1 is made to carry a portable terminal, and have the portable terminal display the current position of the user.

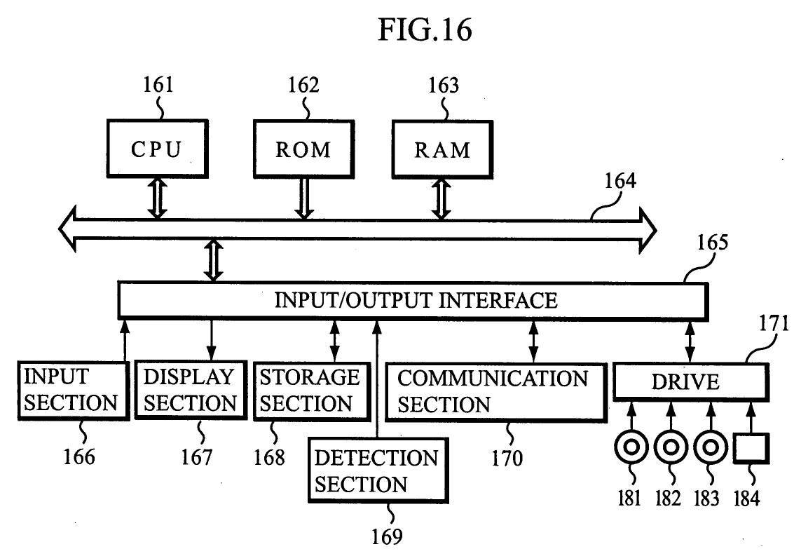

FIG. 16 illustrates a configuration example of a portable terminal 151 for use in such a case. A CPU 161, a ROM 162, a RAM 163, a bus 164, and an input/output interface 165 have functions similar to CPU 41 through input/output interface 45 of the control apparatus 3 of FIG. 3.

An input section 166 connected to the input/output interface 165 is configured with, for example, a tablet or the like, and is arranged on the top surface of a display section 167 configured with an LCD or the like. The user inputs various information by operating the input section 166 using a pen or the like not shown in drawing. This input section 166 is formed of a transparent member, and allows the user to view a display on the display section 167 arranged on the reverse side. A storage section 168 is configured with a semiconductor memory and the like, and necessary information is stored as appropriate.

A detection section 169 has a configuration similar to the above-mentioned detection section 5. A communication section 170 communicates with the control apparatus 3.

As in the control apparatus 3 of FIG. 3, a drive 171 is connected to the input/output interface 165, a magnetic disk 181, an optical disc 182, a magneto-optical disc 183, a semiconductor memory 184 and the like are loaded as appropriate, and programs and the like are loaded.

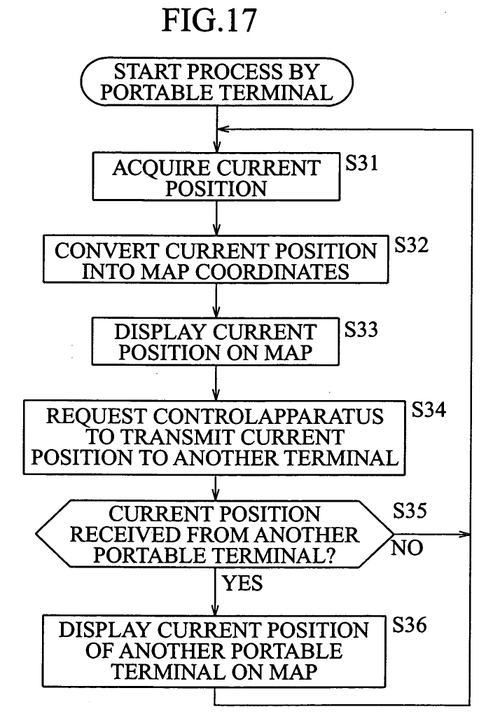

Next, a process by the portable terminal 151 will be described with reference to the flowchart of FIG. 17. First, in step S31, the CPU 161 acquires the current position from an output of the detection section 169. In other words, in the case of this example, map data of the area 1 is stored in the storage section 168 in advance. In this map data, the positions of the light beacons 2-1 to 2-5 are also registered in advance. When the current position of the portable terminal 151 relative to the light beacons 2-1 to 2-5 is acquired from the output of the detection section 169, the CPU 161 performs, in step S32, a process for converting the relative position into coordinates on the map within the area 1.

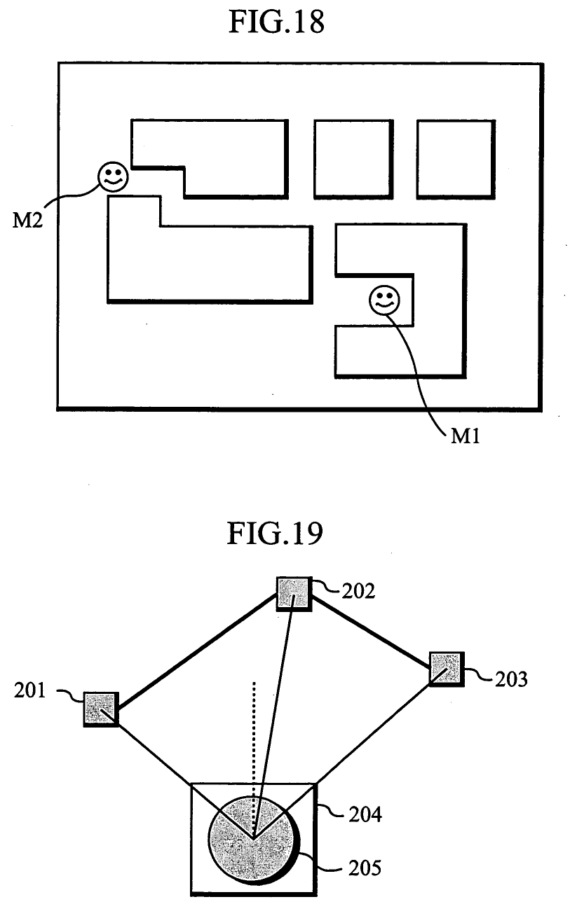

In step S33, the CPU 161 superimposes a mark M1, which is the current position on the map converted in step S32, on the map data of the position mentioned above stored in the RAM 163 and records it. This map data is read from the RAM 163, is outputted to and displayed on the display section 167. Thus, as shown in FIG. 18 for example, its own current position is displayed on the map on the display section 167 as the mark M1.

Next, in step S34, the CPU 161 transmits its own current position to a portable terminal 151 of another user located within the area 1. In other words, at this point, the CPU 161 controls the communication section 170 to request the control apparatus 3 to transmit its own current position to the other portable terminal 151 located within the area 1. Upon receipt of this request via the communication section 49, the CPU 41 of the control apparatus 3 transmits the current position of that portable terminal 151 to the other portable terminal 151 located within the area 1 via the communication section 49.

A similar process is also performed by the other portable terminal 151. As a result, its current position is transmitted from the other portable terminal 151.

As such, in step S35, the CPU 161 of the portable terminal 151 determines whether or not the current position has been transmitted from the other portable terminal 151 via the control apparatus 3. If it has been transmitted, the CPU 161 receives it, and in step S36, draws the current position of that portable terminal 151 in the RAM 163, reads it and displays it on the display section 167.

Thus, the current position of the other portable terminal 151 is displayed as a mark M2 as shown in FIG. 18.

Thereafter, the process returns to step S31, and the processes subsequent thereto are repeatedly executed.

Thus, each user is able to know each other's current positions within the area 1.

FIG. 19 illustrates another mode. In this mode, a remote commander 204 has a detection section 205. This detection section 205 has a configuration similar to the detection section 5 shown in FIG. 5.

In addition, the remote commander 204 is designed such that it is shared between three apparatuses, which are a web television receiver 201, a video cassette recorder (VCR) 202, and a facsimile apparatus 203.

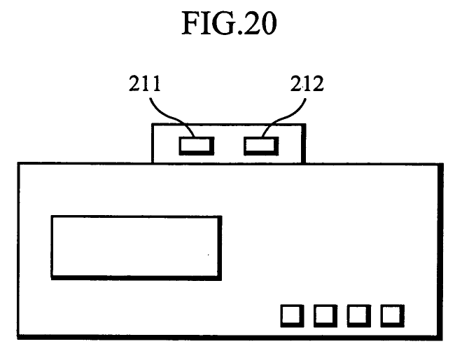

Further, the VCR 202 has, as shown in FIG. 20 for example, an IR generation section 212, in addition to an IR reception section 211 for receiving an infrared signal from the remote commander 204. This IR generation section 212 has a function similar to the light beacon 2 in FIG.

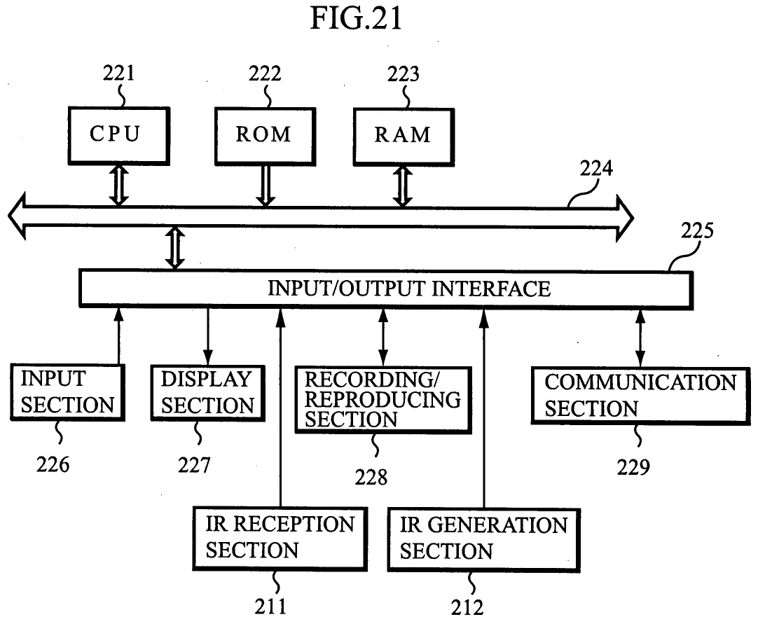

FIG. 21 illustrates a more detailed internal configuration example of the VCR 202. CPU 221 through input/output interface 225 have functions similar to CPU 41 through input/output interface 45 in FIG. 3.

An input section 226 is configured with switches, buttons and the like, and is operated by a user. A display section 227 is configured with an LCD or the like and displays various messages and the like. A recording/reproducing section 228 records or reproduces image signals on or from the magnetic tape of a video cassette that is loaded. A communication section 229 communicates with the web television receiver 201 and the facsimile apparatus 203 via a network such as, for example, an IEEE1394 high-speed serial bus.

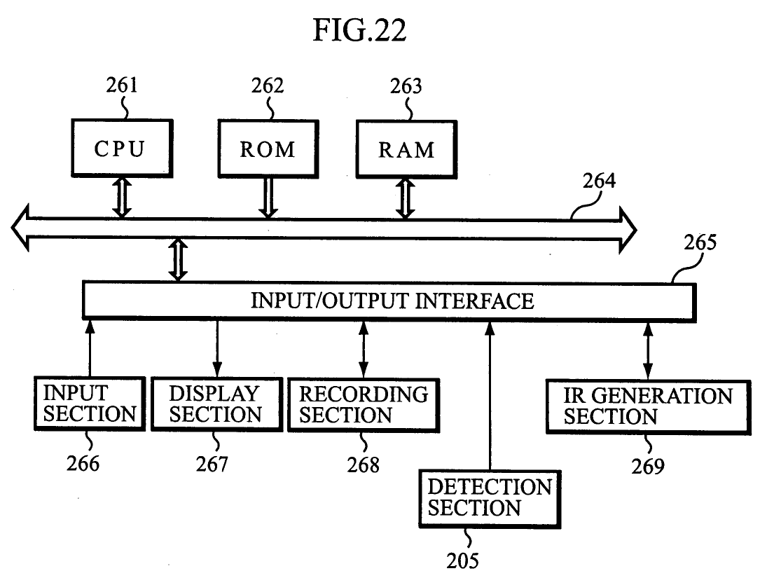

The remote commander 204 is configured, for example, as shown in FIG. 22. CPU 261 through input/output interface 265 thereof also have functions that are basically similar to CPU 41 through input/output interface 45 in FIG. 3.

An input section 266 is configured with a transparent tablet, in addition to switches, buttons and the like, and is operated by a user. A display section 267 is configured with an LCD or the like, and displays various GUIs (Graphical User Interfaces) to the user. A storage section 68 is configured with a semiconductor memory and the like, and stores necessary data as appropriate. When the input section 266 is operated by the user, an IR generation section 269 outputs to the IR reception section 211 of the VCR 202 an infrared signal corresponding to that operation.

Note that although not shown in the drawings, the web television receiver 201 and the facsimile apparatus 203 similarly have an IR reception section for receiving an infrared signal from the remote commander 204 and an IR generation section for outputting an infrared signal including their respective identification numbers.

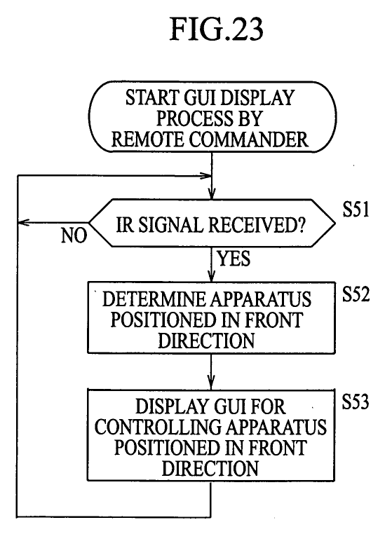

Next, a GUI display process by the remote commander 204 will be described with reference to the flowchart of FIG. 23. In step S51, the CPU 261 monitors the output from the detection section 205, and waits until it receives an infrared signal from the web television receiver 201, the VCR 202, or the facsimile apparatus 203. When it is determined that an infrared signal has been received, the CPU 261 proceeds to step S52, and determines, based on the received infrared signal, which of the web television receiver 201, the VCR 202, and the facsimile apparatus 203 the apparatus located in the front direction is.

In step S52, what the apparatus located in the front direction is can be determined from an identification number of the infrared signal that is incident approximately in the center of the PSD 102. In the storage section 268, identification numbers of the web television receiver 201, the VCR 202, and the facsimile apparatus 203 are registered in advance. The CPU 261 determines the apparatus located in the front direction by determining which of the pre-stored identification numbers of the three apparatuses the identification number included in the infrared signal incident approximately in the center of the PSD 102 is.

And in step S53, the CPU 261 displays a GUI for controlling the apparatus positioned in the front direction on the display section 267.

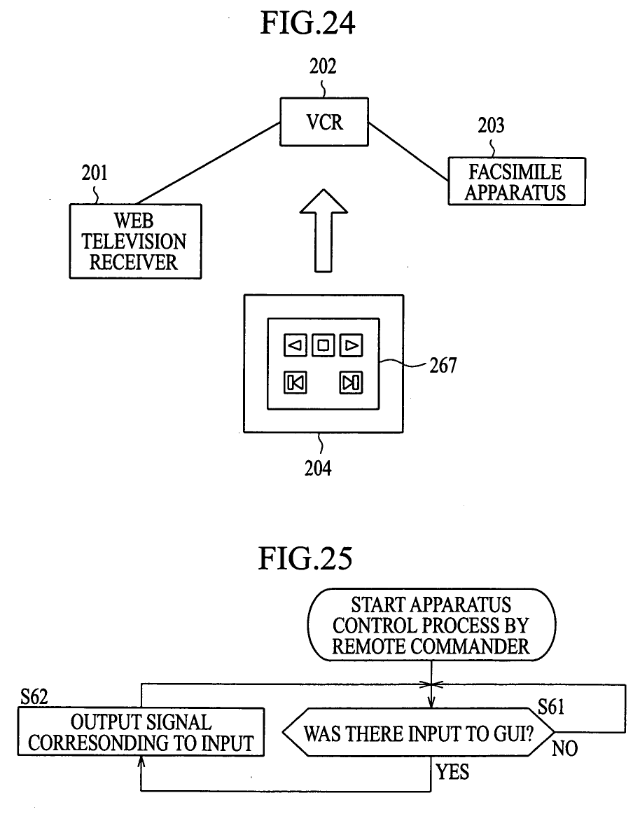

As shown in FIG. 24, for example, when the VCR 202 is positioned in front of the remote commander 204, the CPU 261 of the remote commander 204 displays a GUI for controlling the VCR 202 on the display section 267 thereof. In the example of FIG. 24, buttons for inputting commands of high-speed rewind, reverse-play, stop, play, and fast-forward to the VCR 202 are displayed as a GUI.

A process, in a case where a user operates the remote commander 204 in a state in which a GUI for the apparatus thus positioned in front will be described with reference to the flowchart of FIG. 25.

The CPU 261 determines, in step S61, whether or not there has been an input to the GUI displayed on the display section 267. In other words, when the user wishes to command the VCR 202 to play, the user operates the play button from among the GUI displayed on the display section 267, as shown in FIG. 24, for example. This operation is sensed by the input section 266, and the CPU 261 is notified.

When, in step S61, it is determined that there has been an input with respect to the GUI, the CPU 261 proceeds to step S62, and causes an infrared signal corresponding to that input to be outputted from the IR generation section 269.

The infrared signal outputted from this IR generation section 269 is received by the IR reception section of the apparatus positioned in front. In the case of the example of FIG. 24, this infrared signal is received by the IR reception section 211 of the VCR 202.

When the infrared signal from the remote commander 204 is received from the IR reception section 211, if it is, for example, one that commands playing, the CPU 221 of the VCR 202 controls the recording/reproducing section 228 and makes it play the loaded video cassette. The reproduced signal is supplied to, for example, the web television receiver 201 and is displayed.

Thus, in this example, because a GUI for operating the apparatus facing in front is displayed on the display section 267, the user need only turn the remote commander 204 towards the apparatus the user wishes to control, and operability is improved.

While the above-described series of processes can be executed through hardware, it can also be executed through software.

To perform the series of processes through software, a program configuring the software is installed, from a network, a recording medium and the like, to a computer that is incorporated into dedicated hardware, or to, for example, a general-purpose personal computer that is capable of performing various functions by having various programs installed.

This recording medium is configured not only with, for example as shown in FIG. 3 or FIG. 6, packaged media, which are distributed separately from the main body of the apparatus to provide users with programs and in which the program is recorded, including magnetic disks 61, 181 (including floppy disks), optical discs 62, 182 (including CD-ROMs (Compact Disc-Read Only Memories) and DVDs (Digital Versatile Discs)), magneto-optical discs 63, 183 (including MDs (Mini-Discs)), or semiconductor memories 64, 184, but also with the ROM 42 or a hard disk included in the storage section 48 which are incorporated into the main body of the apparatus and provided to users as such, and in which the program is recorded.

Note that in the present specification, the steps describing the programs recorded in the recording media may include not only processes performed chronologically in the order they are described, but also processes performed in parallel or individually, and not necessarily processed chronologically.

Further, in the present specification, a system refers to an entire apparatus configured with a plurality of apparatuses.

### INDUSTRIAL APPLICABILITY

Thus, according to the information processing apparatus and method, and the program of the present invention, since optical signals generated by a plurality of generating apparatuses are received, and the identification information of the generating apparatuses and the directions of the generating apparatuses are detected based on the received signals, it is possible to realize an information processing apparatus which is capable of providing a user with various information without complicating its configuration.

Further, according to the information processing system and method, and the program of the present invention, since optical signals are generated by a plurality of generating apparatuses, and an information processing apparatus is made to detect the identification information of the generating apparatuses and the directions of the generating apparatuses based on the received signal, it is possible to realize an information processing system which is capable of providing a user with various information without complicating its configuration.

1. An information processing apparatus characterized in that it comprises:
receiving means for receiving optical signals generated by a plurality of generating apparatuses arranged at predetermined positions; and
detection means for detecting identification information of said generating apparatus and a direction of said generating apparatus based on the signal received by said receiving means.

2. The information processing apparatus according to claim 1 characterized in that said detection means includes photoelectric conversion means for generating a voltage corresponding to the direction from which said optical signal is received.

3. The information processing apparatus according to claim 1 characterized in that said detection means further detects a position of said information processing apparatus.

4. The information processing apparatus according to claim 3 characterized in that it further comprises
display means for displaying the position of said information processing apparatus detected by said detection means.

5. The information processing apparatus according to claim 1 characterized in that it further comprises
display means for displaying, based on said identification information detected by said detection means, a GUI corresponding thereto.

6. An information processing method characterized in that it comprises:
a receiving step of receiving optical signals generated by a plurality of generating apparatuses arranged at predetermined positions; and
a detection step of detecting identification information of said generating apparatus and a direction of said generating apparatus based on the signal received in the process of said receiving step.

7. A program for causing a computer to perform:
a receiving step of receiving optical signals generated by a plurality of generating apparatuses arranged at predetermined positions; and
a detection step of detecting identification information of said generating apparatus and a direction of said generating apparatus based on the signal received in the process of said receiving step.

8. An information processing system configured with a plurality of generating apparatuses arranged at predetermined positions and an information processing apparatus that receives optical signals generated by said generating apparatuses, the information processing system characterized in that:
said generating apparatus comprises
generation means for generating an optical signal including identification information for identifying itself such that it does not coincide with a timing in which another generating apparatus generates an optical signal; and
said information processing apparatus comprises:
receiving means for receiving the optical signal generated by said generation means; and
detection means for detecting the identification information of said generating apparatus and the direction of said generating apparatus based on the signal received by said receiving means.

9. An information processing method for an information processing system configured with a plurality of generating apparatuses arranged at predetermined positions and an information processing apparatus that receives optical signals generated by said generating apparatuses, the information processing method characterized in that:
an information processing method of said generating apparatus comprises
a generation step of generating an optical signal including identification information for identifying said generating apparatus such that it does not coincide with a timing in which another generating apparatus generates an optical signal; and
an information processing method of said information processing apparatus comprises
a receiving step of receiving the optical signal generated in the process of said generation step, and
a detection step of detecting the identification information of said generating apparatus and a direction of said generating apparatus based on the signal received in the process of said receiving step.

10. A program executed by a computer that controls a plurality of generating apparatuses arranged at predetermined positions and an information processing apparatus that receives optical signals generated by said generating apparatuses, the program characterized in that:
a program of said generating apparatus comprises
a generation step of generating an optical signal including identification information for identifying said generating apparatus such that it does not coincide with a timing in which another generating apparatus generates an optical signal; and
a program of said information processing apparatus comprises
a receiving step of receiving the optical signal generated in the process of said generation step, and
a detection step of detecting the identification information of said generating apparatus and a direction of said generating apparatus based on the signal received in the process of said receiving step.
